(19) United States
(12) Patent Application Publication
(10) Pub. No.: US 2016/0089741 A1
(43) Pub. Date: Mar. 31, 2016

(54) GAS COOLING DEVICE AND REFLOW OVEN USING THEREOF

(71) Applicants: Maintek Computer (Suzhou) Co., Ltd., Suzhou (CN); PEGATRON CORPORATION, TAIPEI CITY (TW)

(72) Inventors: De-Qaing XU, Suzhou (CN); JUNG-KUEI CHUNG, Suzhou (CN)

(21) Appl. No.: 14/866,247

(22) Filed: Sep. 25, 2015

(30) Foreign Application Priority Data
Sep. 30, 2014 (CN) 201420573664.2

(51) Int. Cl. B23K 3/08; B23K 3/04

(52) U.S. Cl. CPC B23K 3/085; B23K 3/04

(57) ABSTRACT

The present invention discloses a gas cooling device and a reflow oven using thereof. The gas cooling device comprises a liquid cooling machine, a plurality condensers and a plurality of outer sleeves. The condensers are disposed in parallel and connected to the liquid cooling machine, in which two ends of all the condensers are separately connected with valves. The outer sleeves are sleeved out of the condensers and communicatively connected in order, in which the outer sleeves disposed at two ends are provided, respectively, with a gas inlet and a gas outlet and each of the condensers is provided with a water outlet. Each of the condensers is formed a circulation with the cooling device. Even though any of the condensers is detached, other condensers are able to continue operating as long as the valves disposed at the two ends of the detached condenser are closed.

### CROSS-REFERENCE TO RELATED APPLICATIONS

This Non-provisional application claims priority under 35 U.S.C. §119(a) on China Patent Application No(s). 201420573664.2 filed in Sep. 30, 2014, the entire contents of which are hereby incorporated by reference.

### BACKGROUND

1. Technology Field

This disclosure relates to a device for cooling gas into liquid and a reflow oven having the device, and more particularly, to a gas cooling device using condensers and a reflow oven having the device.

2. Description of the Related Art

In every welding processes of the prior art, flux is not only used in a usage process of a reflow oven but also in the welding process performed on a print circuit board for stabilizing the welding process. In the welding process, partial flux will be vaporized into flux air and the flux air needs to be cooled into liquid to be recycled for use.

Please refer to FIG. 3, a gas cooling device of the prior art for cooling the flux air comprises a liquid cooling machine 91, a plurality of condensers 92, and a plurality of outer sleeves 93. The liquid cooling machine 91 can be a chiller or other kinds. The condensers 92 are disposed in series and connected with the liquid cooling machine 91. The liquid cooling machine 91 and the condensers 92 are formed a circulation jointly, and water is circulated to flow in the circulation. The outer sleeves 93 are sleeved, respectively, out of the condensers 92 and communicatively connected in order, in which the outer sleeves 93 disposed at two ends are provided, respectively, with a gas inlet 931 and a gas outlet 932 and the bottom of each outer sleeve 93 is provided with a water outlet 933.

In use, the gas to be cooled enters the outer sleeve 93 through the gas inlet 931 disposed at one end of the outer sleeve 93. After entering, the gas will contact the condenser 92 and perform heat exchange with the cold water in the condenser 92 via the outer wall of the condenser 92 to allow the gas to be cooled into the liquid. The liquid will downwardly flow into the water outlet 933 to be recycled. In addition, the remained gas that are not cooled into the liquid will move to the next outer sleeve 93 and perform heat exchange with the condenser 92 in the next outer sleeve 93. The gas decreases by moving between the outer sleeves 93 and then is exhausted from the gas outlet 932 of the outer sleeve 93 disposed at the end. The temperature of the water in each of the condensers 92 will be raised due to the heat exchange, and the water will return to the liquid cooling machine 91 to be cooled again into the cold water for circulating.

When the gas contacts the condensers 92, however, dirty and greasiness in the gas will be condensed to viscous and attached on the outer wall of the condensers 92. Therefore, the condensers 92 need to be detached periodically for cleaning and maintaining. Please refer to FIG. 4, the condensers 92 are disposed in series. After any one of the condensers 92 is detached, the circulation formed by the condensers 92 and the liquid cooling machine 91 will be interrupted so that the cold water cannot circulate to flow inside. Thus, the operation of the gas cooling device and the reflow oven are required to stop until the maintenance of all the condensers 92 is finished.

However, the gas cooling device may be provided with a plurality of condensers 92 according to different cooling ability (twenty condensers 92 may be used under a specific condition) so that it will spend a lot of time to maintain all the condensers 92. In particular, three times of the maintenance a day are essential and each of the maintenance is performed for 30 minutes or higher. Thus, the device will be stopped to maintain for one and half hours a day and it results in much inconvenience.

### SUMMARY

According to the disadvantages and insufficiency of the prior art, an aspect of the invention is to provide a gas cooling device and a reflow oven using the same in which the gas cooling device continues operating after any of the condensers is detached.

To achieve the abovementioned purpose, the present invention provides a gas cooling device comprises a liquid cooling machine, a plurality condensers and a plurality of outer sleeves. The condensers are disposed in parallel and connected to the liquid cooling machine, wherein two ends of all the condensers are separately connected with valves. The outer sleeves are sleeved out of the condensers and communicatively connected in order, wherein the outer sleeves disposed at two ends are provided with a gas inlet and a gas outlet, respectively, and each of the outer sleeves is provided with a water outlet.

According to the embodiment of the gas cooling device, the inlet and the outlet of the liquid cooling machine are connected with valves, respectively.

According to the embodiment of the gas cooling device, the water outlet of each of the outer sleeves is connected with a valve.

According to the embodiment of the gas cooling device, the valves disposed at the two ends of each of the condensers are mechanical valves, the valves disposed at the inlet and the outlet of the liquid cooling machine are mechanical valves, and the valve disposed at the water outlet of each of the outer sleeves is mechanical valve.

According to the embodiment of the gas cooling device, the liquid cooling machine is a chiller.

According to the embodiment of the gas cooling device, the water outlet of each of the outer sleeve is connected with a recycle bucket.

To achieve the abovementioned purpose, the present invention provides a reflow oven, comprising: a gas cooling device according to abovementioned; and a flux air outlet communicatively connected to the gas inlet of the condenser of the gas cooling device.

Accordingly, the advantage of the present invention is that each of the condensers is formed a circulation with the cooling device because the condensers are disposed in parallel. Even though any of the condensers is detached, other condensers are able to continue operating as long as the valves disposed at the two ends of the detached condenser are closed. Thus, it substantially saves the time that the gas cooling device and the reflow oven are stopped to wait when the condensers are detached to maintain for improving the efficiency in the use of the present invention.

The present invention will be further described by, but not limited to, cooperating the following figures and embodiments.

### BRIEF DESCRIPTION OF THE DRAWINGS

FIG. 1 is a schematic drawing showing a general use of a gas cooling device according to one embodiment of the invention;

FIG. 2 is a schematic drawing showing an use of a gas cooling device after detaching one of condensers according to the embodiment of the invention;

FIG. 3 is a schematic drawing showing a general use of a gas cooling device according to the related art; and

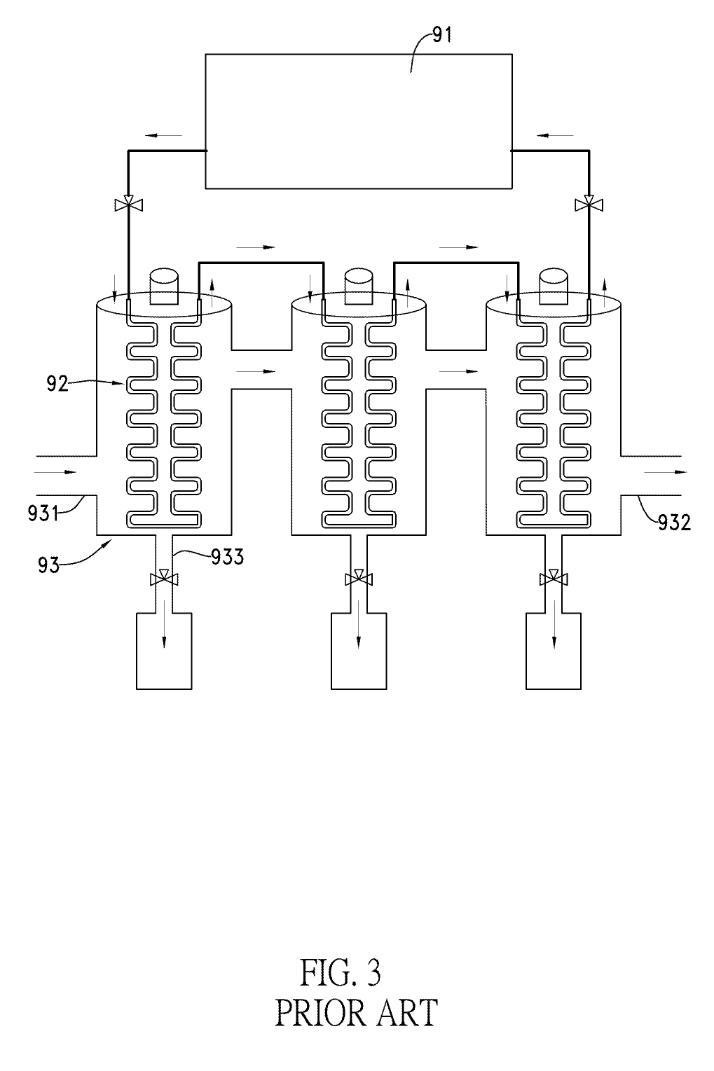

FIG. 4 is a schematic drawing showing an use of a gas cooling device after detaching one of condensers according to the related art;

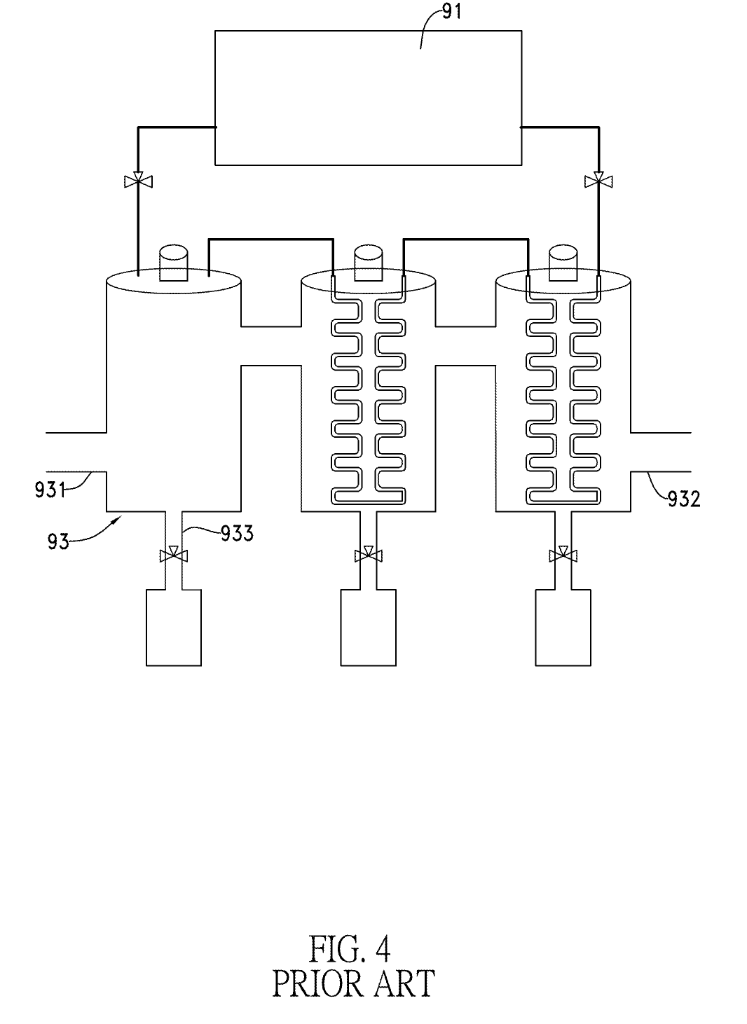

### DETAILED DESCRIPTION

To further illustrate the technological method utilized to achieve the purpose of the present invention, the accompanying drawings and the preferred embodiments of the present utility are described in the following.

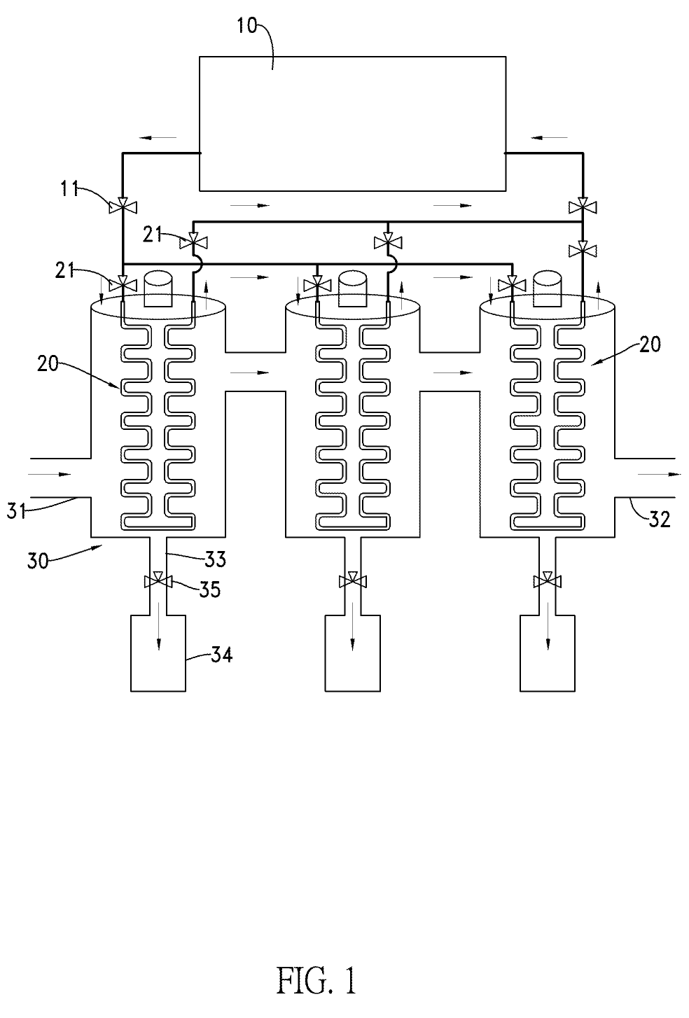

Please refer to FIG. 1, the gas cooling device of one embodiment of the invention comprises a liquid cooling machine 10, a plurality of condensers 20 and a plurality of outer sleeves 30.

A liquid inlet and a liquid outlet of the abovementioned liquid cooling machine 10 are connected with valves 11, separately. In the present embodiment, the liquid cooling machine 10 is, but not limited to, a chiller for cooling the liquid passing through the liquid cooling machine.

The abovementioned condensers 20 are disposed in parallel and connected to the liquid cooling machine 10. Two ends of all the condensers are connected, separately, with valves 21.

The outer sleeves 30 are sleeved out of the condensers 20. The outer sleeves 30 are communicatively connected in order in which the outer sleeves 30 disposed at two ends are provided with a gas inlet 31 and a gas outlet 32, separately. Each of the outer sleeves 30 is provided with a water outlet 33 at its bottom, and the water outlet 33 is connected with a recycle bucket 34. A valve 35 is connected between the water outlet 33 of the outer sleeve 30 and the recycle bucket 34.

In the present embodiment, the condensers 20 downwardly pass into the corresponding outer sleeves 30, spiral to any determined shape in the outer sleeves 30 for increasing the contact area with air and then upwardly passes out the outer sleeves 30. However, the present utility is not limited thereto. The condensers 20 also can pass into or pass out the outer sleeves 30 from another direction, and the shape of the condensers 20 in the outer sleeves 30 can be changed according to the needs.

In the present embodiment, the valves 11 disposed at the inlet and the outlet of the liquid cooling machine 10 are mechanical valves, the valves 21 disposed at the two ends of each of the condensers 20 are mechanical valves, and the valve 35 disposed at the water outlet of each of the outer sleeves 30 is mechanical valve. However, the valves mentioned above are not limited thereto and able to be an electromagnetic valve or other kinds of valves.

The reflow oven of the present utility comprises a ling chamber, a transfer device, a heater, a cooler and the abovementioned gas cooling device. A flux air outlet is disposed on the long chamber and connected to the gas inlet 31 of the outer sleeve 30 of the gas cooling device. The transfer device is disposed in the long chamber. The heater and the cooler are disposed, separately, corresponding to different sites of the long chamber.

When the reflow oven is in use, a printed circuit board assembly is placed on the transfer device to enter into the long chamber through one end of the long chamber and depart from the long chamber through the other end of the long chamber. The printed circuit board assembly is heated in the long chamber, and the flux will be vaporized into the flux air during the heating in which the flux air will be exhausted from the flux air outlet to the gas inlet 31 of the outer sleeve 30 of the gas cooling device. The flux air passes the outer sleeves 30 in order, and a portion of the flux air will be cooled into the liquid that is dropped into each recycle bucket 34 and the remains will be exhausted via the gas outlet 32 of the outer sleeve 30.

When the gas cooling device is in normal use, cold water will enter each of the condensers 20, which are disposed in parallel, simultaneously, after the cold water is drained from the outlet of the liquid cooling machine 10. The cold water of the condensers 20 will perform heat exchange with air entered into the outer sleeves 30, and then the water of each of the condensers 20 will be collected and returned to the liquid cooling machine 10 for further cooling and cycling. The liquid cooled from the gas will drop into the recycle bucket 34 to be collected.

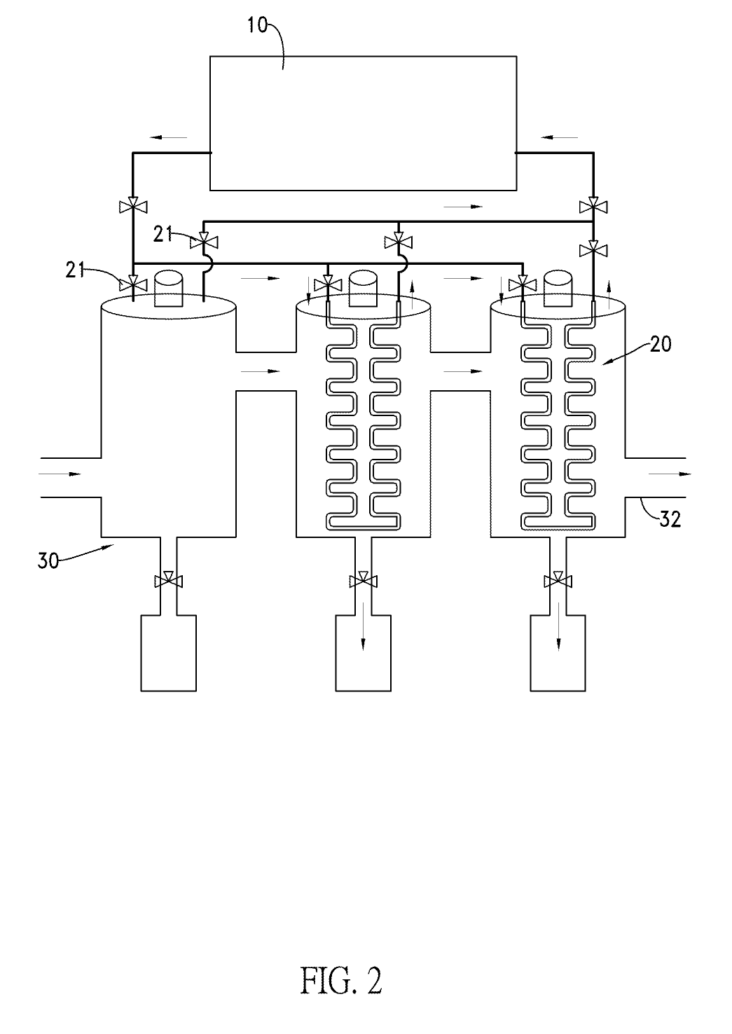

Please refer to FIG. 2, the gas cooling device and the reflow oven are only stopped temporarily to maintain the condensers 20. The gas cooling device and the reflow oven can operate continually after the valves 21 disposed at the two ends of the condenser 20 to be detached are closed and the condenser 20 is removed. The air will pass through the outer sleeve 30 that is empty and move into the net outer sleeve 30 directly, and the cold water will enter the remained condensers 20 directly to be circulated. Thus, the gas cooling device and the reflow oven are able to keep operating even though the condenser 20 is detached to maintain. Furthermore, the gas cooling device and the reflow oven are also stopped for a while if the condenser 20 needs to be assembled back after the maintenance finishes.

The embodiment of the invention can substantially save the time that the gas cooling device and the reflow oven are stopped to wait when the condensers are detached to maintain so that the efficiency in the use of the present utility can be improved.

When the embodiment is in use, the intermediate circulated to flow in the condensers 20 and the liquid cooling machine 10 is, but not limited to, clean water in the present embodiment. The other appropriate intermediate is also available.

The gas cooling device of the embodiment cannot only be utilized for cooling the flux air in the reflow oven and the welding but also for cool the gas under any necessary situation.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A gas cooling device, comprising:
a liquid cooling machine;
a plurality of condensers disposed in parallel and connected to the liquid cooling machine, wherein two ends of all the condensers are separately connected with valves; and
a plurality of outer sleeves sleeved out of the condensers and communicatively connected in order, wherein the outer sleeves disposed at two ends are provided with a gas inlet and a gas outlet, respectively, and each of the outer sleeves is provided with a water outlet.

2. The gas cooling device according to claim 1, wherein the inlet and the outlet of the liquid cooling machine are connected with valves, respectively.

3. The gas cooling device according to claim 2, wherein the water outlet of each of the outer sleeves is connected with a valve.

4. The gas cooling device according to claim 3, wherein the valves disposed at the two ends of each of the condensers are mechanical valves, the valves disposed at the inlet and the outlet of the liquid cooling machine are mechanical valves, and the valve disposed at the water outlet of each of the outer sleeves is mechanical valve.

5. The gas cooling device according to claim 1, wherein the liquid cooling machine is a chiller.

6. The gas cooling device according to claim 1, wherein the water outlet of each of the outer sleeve is connected with a recycle bucket.

7. A reflow oven, comprising:
a gas cooling device according to claim 1; and
a flux air outlet communicatively connected to the gas inlet of the condenser of the gas cooling device.
